(19) United States
(12) Patent Application Publication
(10) Pub. No.: US 2011/0242184 A1
(43) Pub. Date: Oct. 6, 2011

(54) IMAGE FORMING DEVICE

(75) Inventor: Yasuhiko KACHI, Kanagawa (JP)

(73) Assignee: FUJIFILM CORPORATION, Tokyo (JP)

(21) Appl. No.: 13/005,553

(22) Filed: Jan. 13, 2011

(30) Foreign Application Priority Data
Mar. 30, 2010 (JP) 2010-079612

(51) Int. Cl. B41J 29/38

(52) U.S. Cl. 347/17

(57) ABSTRACT

An image forming device including a droplet ejection head, a medium temperature detection unit, a storage unit and a medium temperature control unit. The droplet ejection head ejects droplets including a volatile component at a recording medium. The medium temperature detection unit detects a temperature of the recording medium. The storage unit stores impact area information representing a relationship between temperatures of the recording medium and impact areas of droplets impacting on the recording medium. On the basis of the temperature of the recording medium detected by the medium temperature detection unit and the impact area information stored by the storage unit, the medium temperature control unit controls the temperature of the recording medium such that the impact areas of the droplets impacting on the recording medium become a pre-specified impact area.

### CROSS-REFERENCE TO RELATED APPLICATION

This application is based on and claims priority under 35 USC 119 from Japanese Patent Application No. 2010-079612 filed on Mar. 30, 2010, which is incorporated by reference herein.

### BACKGROUND

1. Technical Field

The present invention relates to an image forming device, and particularly relates to an image forming device that controls impact areas of impacting droplets.

2. Related Art

In an inkjet recording device, areas or dot diameters of droplets impacting on a recording medium have a great effect on image quality. Accordingly, Japanese Patent Application Laid-Open (JP-A) No. 2005-096277 recites details of a required dot diameter being obtained by a temperature being adjusted to take account of spreading of dots in accordance with wetting characteristics of an ink, in relation to surface energy of a recording medium, and of spreading of dots in accordance with ink viscosity.

Specifically, when the temperature of a recording medium rises and ink viscosity falls, a dot diameter increases (a dot height becomes lower). However, an ink mentioned in the recitations in JP-A No. 2005-096277 is presumed to be a UV ink, and there is almost no volatile component(s) in this ink.

Meanwhile, JP-A No. 2006-240009 recites that a dot spread from ink impact until UV irradiation varies in accordance with ink viscosity. In JP-A No. 2006-240009, details are recited of memorizing data on the spreading of dots beforehand and obtaining a required dot diameter by temperature adjustment. Specifically, when the temperature of a recording medium rises and ink viscosity falls, a dot diameter increases (a dot height becomes lower). However, an ink mentioned in the recitations in JP-A No. 2006-240009 is presumed to be a UV ink, and there is almost no volatile component in the ink.

JP-A No. 2005-041011 recites details of variably controlling ink ejection amounts in order to obtain a required color characteristic (density), taking account of a characteristic of dot diameters changing because a permeation rate of a medium changes when the temperature changes. As an example, details are recited of ink viscosity falling and dot diameters increasing in conditions with high temperatures, comparing 15° C. and 25° C.

In the technologies recited in JP-A Nos. 2005-096277 and 2006-240009, details of controlling a recording material at an image formation area or a temperature of an impact vicinity and obtaining dot diameters to produce an optimum image are disclosed for ink materials that do not include volatile components, such as UV ink. However, impact dot diameters are affected by temperature—viscosity characteristics and constraints on a time until UV curing. Therefore, a control range of required dot diameters is narrow, and because the UV inks do not include volatile components, it is not possible to provide thin-film image layers (i.e., glossiness is poor).

The technology disclosed in JP-A No. 2005-041011 gives details of using ejected ink amounts to correct differences in dot diameters after impact in environments in which ink viscosities are different (15° C. and 25° C.), correcting the ink ejection amounts such that the dot diameters after impact are the same, and obtaining an image. However, because the ink amounts are different, colorant thicknesses are different when the dot diameters are made the same, and density differences arise. Moreover, because the ink amounts are variable, the thickness (solid component amount) of the image layer changes and there is a change in glossiness.

With these related art technologies, it is not possible to control the impact areas when droplets that include volatile components are impacting.

### SUMMARY

In consideration of the problem described above, an object of the present invention is to provide an image forming device capable of controlling impact areas when droplets including a volatile component are impacting.

An image forming device relating to an aspect of the present application includes: a droplet ejection head that ejects droplets including a volatile component at a recording medium; a medium temperature detection unit that detects a temperature of the recording medium; a storage unit that stores impact area information representing a relationship between temperatures of the recording medium and impact areas of droplets impacting on the recording medium; and a medium temperature control unit that, on the basis of the temperature of the recording medium detected by the medium temperature detection unit and the impact area information stored by the storage unit, controls the temperature of the recording medium such that impact areas of the droplets impacting on the recording medium are substantially equal to a pre-specified impact area.

### BRIEF DESCRIPTION OF THE DRAWINGS

An exemplary embodiment of the present invention will be described in detail based on the following figures, wherein:

FIG. 1 is an example of an overall structural diagram of an inkjet recording device relating to an exemplary embodiment.

FIG. 2 is a schematic plan diagram of peripheries of printing sections of the inkjet recording device.

FIG. 3 is a through-view plan diagram illustrating rows constituting a head.

FIG. 4 is a magnified diagram in which a portion of the rows constituting the head is magnified.

FIG. 5 is a sectional diagram illustrating three-dimensional structure of a droplet ejection element.

FIG. 6 is a block diagram illustrating an example of system structure of the inkjet recording device.

FIG. 7A is a graph illustrating an example of a relationship between temperature and dot diameter.

FIG. 7B is a graph illustrating an example of a relationship between temperature and dot pile height.

FIG. 8A is a schematic view illustrating a state of spreading of ink.

FIG. 8B is a schematic view illustrating a state of spreading of ink.

FIG. 9A is a graph illustrating an example of a relationship between density and glossiness.

FIG. 9B is a view illustrating an example of a relationship between impact area and glossiness.

FIG. 10 is a flowchart illustrating a flow of impact area control processing.

FIG. 11 is a flowchart illustrating a flow of pile height control processing.

FIG. 12 is a diagram illustrating an example of a configuration of heaters in a shuttle system.

### DETAILED DESCRIPTION

Herebelow, an exemplary embodiment of the present invention is described in detail with reference to the attached drawings. Herein, the droplets in the present exemplary embodiment (hereinafter referred to as ink) have a viscosity of 11 cp at room temperature, include a colorant, a dye and a polymer, and components thereof include pigment at 6%, resin at 7% and organic solvent at 80%, but the ink is not to be limited thus. However, the ink must include a volatile component.

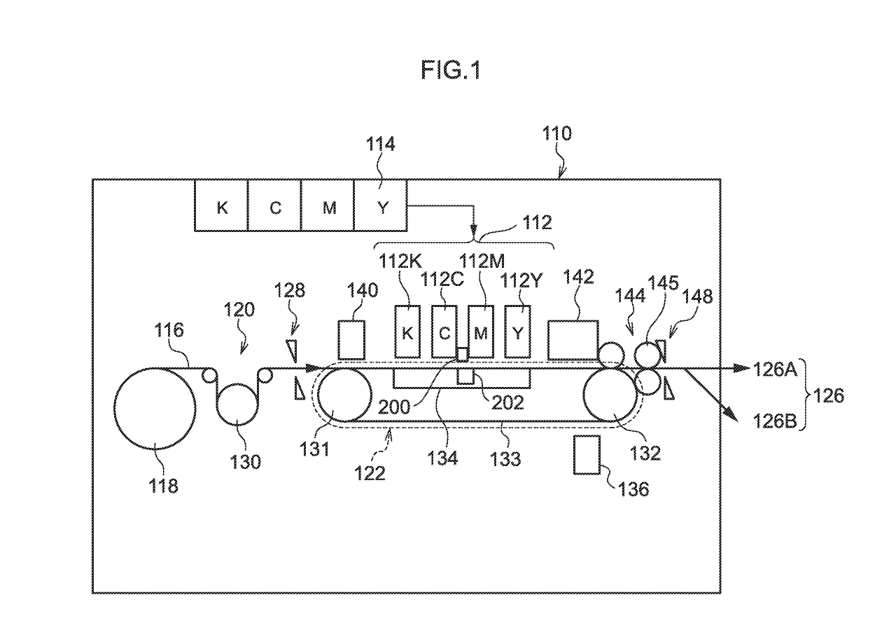

FIG. 1 is an overall structural diagram of an inkjet recording device that represents an exemplary embodiment of the image recording device relating to the present invention. As illustrated in FIG. 1, this inkjet recording device 110 is equipped with a printing section 112, an ink storage/charging section 114, a paper supply section 118, a de-curling processing section 120, a belt conveyance section 122, a pre-heater 140, an impact region heater 134, a drying heater 142, a medium temperature detection section 200, an impact region temperature detection section 202 and a paper ejection section 126. The printing section 112 includes a plural number of inkjet recording heads (droplet ejection heads, which are below referred to as “heads”) 112K, 112C, 112M and 112Y, which are provided to correspond to inks of black (K), cyan (C), magenta (M) and yellow (Y). The ink storage/charging section 114 stores inks to be supplied to the heads 112K, 112C, 112M and 112Y. The paper supply section 118 supplies recording paper 116, which is a recording medium. The de-curling processing section 120 removes curl of the recording paper 116. The belt conveyance section 122 is disposed to oppose nozzle faces (ink ejection faces) of the printing section 112, and conveys the recording paper 116 while maintaining flatness of the recording paper 116. The pre-heater 140 regulates temperature of the recording paper 116. The impact region heater 134 regulates temperature of an impact region at which ink impacts on the recording paper. The drying heater 142 volatilizes volatile components included in the inks that have impacted on the recording paper 116 after recording. The medium temperature detection section 200 detects a temperature of the recording paper. The impact region temperature detection section 202 detects a temperature of the impact region. The paper ejection section 126 ejects the recording paper after recording (printed matter) to outside the inkjet recording device 110. In the present specification, the term “printing” includes both printing of text and printing of images.

The ink storage/charging section 114 includes ink tanks that store inks of colors corresponding to the heads 112K, 112C, 112M and 112Y. The tanks are in fluid communication with the heads 112K, 112C, 112M and 112Y via required piping. The ink storage/charging section 114 is equipped with a warning unit that gives a warning when a remaining amount of ink is small, and includes a mechanism for preventing erroneous loading of the wrong color.

In FIG. 1, a magazine of roll paper (continuous paper) is illustrated as an example of the paper supply section 118. However, plural magazines with different paper widths, paper types and the like may be provided together. Furthermore, paper may be supplied by a cassette loaded with a stack of cut paper instead of or in addition to the magazine(s) of roll paper.

The recording paper 116, which is fed from the paper supply section 118, tends to retain winding due to having been loaded in the magazine, and has curl. In order to remove this curl, the de-curling processing section 120 provides heat to the recording paper 116 with a heating drum 130, around which the recording paper 116 is wound in the opposite direction to the direction of the winding tendency. Here, a heating temperature may be controlled such that there is slight curl with the print face to the outer side thereof.

If the apparatus is configured to employ roll paper, a shearing cutter 128 is provided as illustrated in FIG. 1. The roll paper is cut to a desired size by the cutter 128. If cut paper is employed, the cutter 128 is not necessary.

After the de-curling processing, the cut recording paper 116 is fed to the belt conveyance section 122. The belt conveyance section 122 has a structure in which an endless belt 133 is wound between rollers 131 and 132.

The belt 133 has a width dimension greater than a width of the recording paper 116. Numerous suction holes (not illustrated) are formed in a belt face of the belt 133. The belt 133 wound between the rollers 131 and 132 adheres and retains the recording paper 116 on the belt 133 by a suction adherence system or an electrostatic adherence system

Driving force of a motor is transmitted to one or both of the rollers 131 and 132 around which the belt 133 is wound. Accordingly, the belt 133 is driven in the clockwise direction of FIG. 1. Thus, the recording paper 116 retained on the belt 133 is conveyed from the left to the right of FIG. 1.

Ink will be applied to the belt 133 when an edgeless print or the like is printed. Therefore, a belt cleaning section 136 is provided at a predetermined location of the outer side of the belt 133 (a suitable location outside a printing region). Structure of the belt cleaning section 136 is not illustrated in detail. For example, there are systems of nipping with a brush roller, a water-absorbing roller or the like, air-blowing systems which blow on clean air, and combinations thereof. In the case of a system that nips with a cleaning roller, cleaning effects are greater if a linear speed of the roller is different to a linear speed of the belt.

Instead of the belt conveyance section 122, a mode that employs a roller-nipping conveyance mechanism can be considered. However, if a medium is conveyed through a printing region by roller-nipping, a roller will touch against the printed face of the paper immediately after printing, and there will be a problem in that images are likely to be smudged. Therefore, adherence belt conveyance in which the image face is not touched in a printing region thereof is preferable, as in the present example.

The aforementioned pre-heater 140 is provided on a paper conveyance path formed by the belt conveyance section 122, at the upstream side relative to the printing section 112. The pre-heater 140 blows heated air at the recording paper 116 before the printing and thus regulates the temperature of the recording paper 116.

The heads 112K, 112C, 112M and 112Y of the printing section 112 have sizes corresponding to a maximum paper width of the recording paper 116 to which the inkjet recording device 110 will be applied. The heads 112K, 112C, 112M and 112Y are full line-type heads in which the nozzles for ink ejection are plurally arrayed in the nozzle faces thereof over a length exceeding at least one side (the overall width of a printable range) of the maximum-size recording paper 116 (the full width of a range in which image formation is possible).

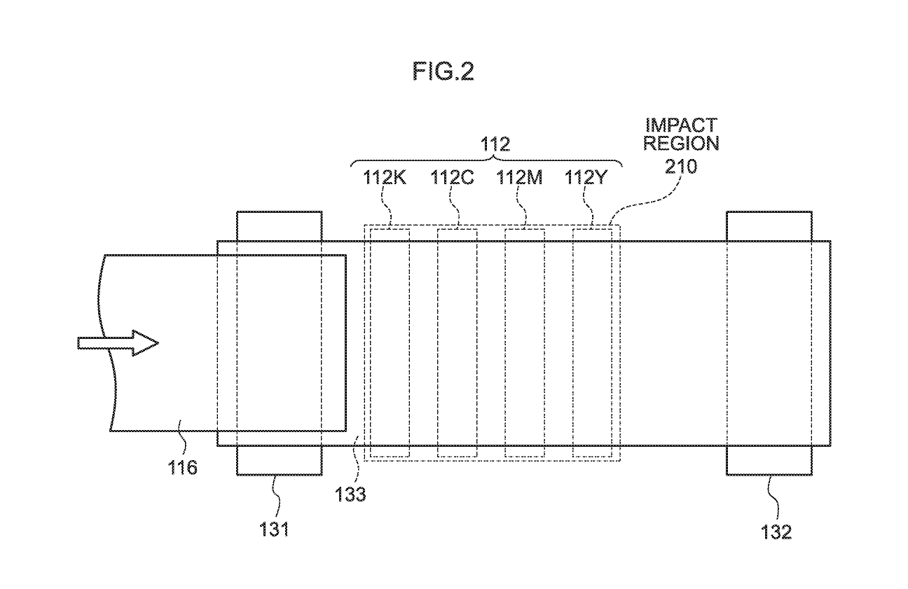

From the upstream side along the direction of conveyance of the recording paper 116, the heads 112K, 112C, 112M and 112Y are arranged in the order black (K), cyan (C), magenta (M) and yellow (Y), as illustrated in FIG. 2. The heads 112K, 112C, 112M and 112Y are each fixedly disposed so as to extend in a direction substantially orthogonal to the direction of conveyance of the recording paper 116.

While the recording paper 116 is being conveyed by the belt conveyance section 122, a color image is formed on the recording paper 116 by the respective inks of the different colors being ejected from the heads 112K, 112C, 112M and 112Y. Thus, a region in which ink impacts on the recording paper 116 is the impact region 210 illustrated in FIG. 2.

Thus, the full line-type heads 112K, 112C, 112M and 112Y with nozzle rows covering the whole of the paper width are provided for the different colors. Therefore, an image may be formed over the whole face of the recording paper 116 in a single cycle of the operation of moving the recording paper 116 and the printing section 112 relatively in the conveyance direction (the sub scanning direction) (that is, by a single cycle of sub scanning) Therefore, higher speed printing is possible than with a shuttle-type head in which a recording head is reciprocatingly moved in a direction orthogonal to the paper conveyance direction, and productivity may be improved.

In this example, a structure with the standard colors KCMY (four colors) is illustrated. However, combinations of ink colors, numbers of colors and the like are not to be limited by the present exemplary embodiment. In accordance with requirements, paler inks, darker inks and special color inks may be added. For example, a configuration is possible in which inkjet heads are added that eject lighter inks such as, for example, light cyan, light magenta and the like. Furthermore, the order of arrangement of the heads of the respective colors is not particularly limited.

Returning to FIG. 1, the impact region heater 134, which is disposed at a lower portion of the printing section 112, regulates the temperature of the impact region 210 in which the inks impact on the recording paper. The impact region heater 134 regulates the temperature just after impact. The impact region heater 134 maintains a balance between viscosity and surface energy in accordance with drying and evaporation of the inks. As specific examples of the impact region heater 134, for example, a film heater that directly heats the impact region 210, an infrared heater or carbon heater that heats the imaging surface of the impact region 210 with directly radiated heat, and the like may be mentioned.

The aforementioned drying heater 142 is provided subsequent to the head 112Y. The drying heater 142 volatilizes volatile components included in the impacted ink. In particular, in the present exemplary embodiment, the drying heater 142 causes volatilization by heating the recording paper 116 to at least the temperature detected by the medium temperature detection section 200. Alternatively, a temperature of the impact region 210 may have been detected beforehand by experiment and the drying heater 142 may cause volatilization by heating the recording paper 116 to at least that temperature.

The pre-heater 140, impact region heater 134 and drying heater 142 described above all heat the recording paper 116. In particular, the impact region heater 134 heats the impact region 210 in addition to the recording paper 116. Herein, only heating of the recording paper 116 and the like is illustrated in the present exemplary embodiment. However, units that cool as necessary may also be added.

When porous paper is being printed on with dye-based ink or the like, pores in the paper may be closed up by pressure. Accordingly, there is an effect in that contact with objects that would cause dye components such as ozone and the like to be broken down is prevented and endurance of images is improved.

A heat/pressure section 144 is provided subsequent to the drying heater 142. The heat/pressure section 144 is a unit for controlling a degree of glossiness of the image surface. The heat/pressure section 144 presses the image surface with a heating roller 145 that features predetermined surface protrusion and indentation shapes, while heating the image surface, and transfers the protrusion and indentation shapes to the image surface.

The printed matter that has been created thus is ejected through the paper ejection section 126. It is preferable if images that are actually intended to be printed (matter on which desired images are printed) and test prints are ejected separately. In this inkjet recording device 110, an unillustrated selection unit is provided, which selects main image printed matter and test print printed matter and switches an ejection path to feed to respective ejection portions 126A and 126B.

If a main image and a test print are formed side by side at the same time on a large piece of paper, the area of the test print is cut off by a cutter 148. Although not illustrated in FIG. 1, a sorter is provided at the main image ejection portion 126A for collating and stacking images.

Next, structure of the heads will be described. The structures of the heads 112K, 112C, 112M and 112Y for the different colors are the same. Therefore, a head with the reference numeral 150 will be illustrated herebelow to represent the heads 112K, 112C, 112M and 112Y.

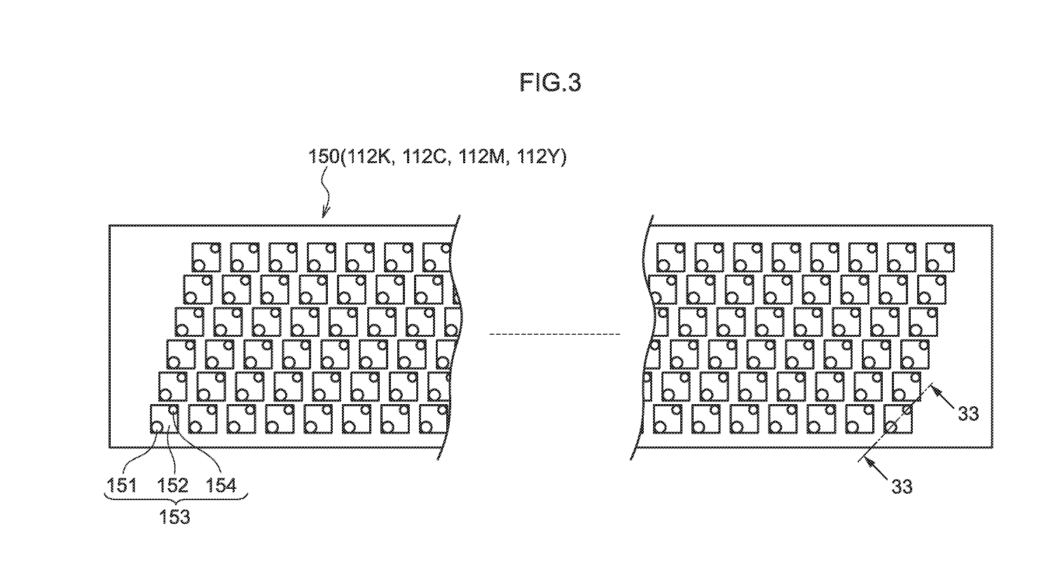

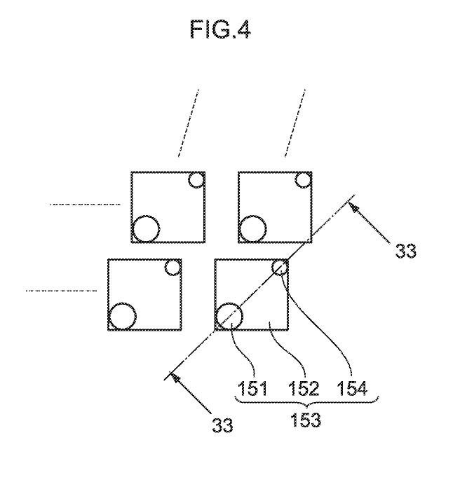

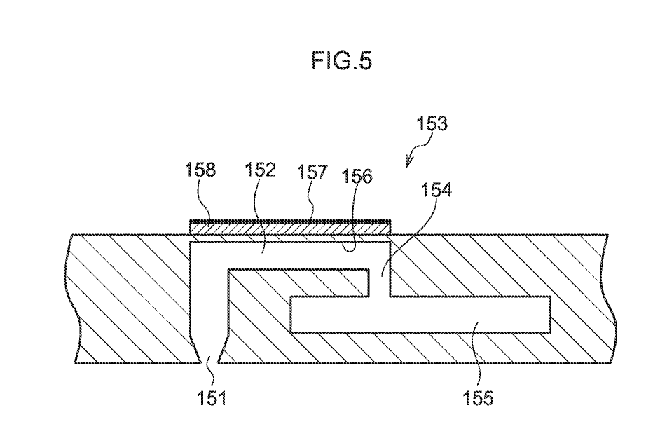

FIG. 3 is a through-view plan diagram illustrating a structural example of the head 150. FIG. 4 is a magnified diagram of a portion of the head 150. FIG. 5 is a sectional diagram (a sectional view cut along line 33-33 in FIG. 4) illustrating three-dimensional structure of a single droplet ejection element (an ink chamber unit that corresponds with a single nozzle 151).

In order to raise a density of the pitch of dots printed on the recording paper 116, it is necessary to raise a density of the pitch of nozzles at the head 150. As illustrated in FIG. 3 and FIG. 4, the head 150 of the present example has a structure in which plural ink chamber units (droplet ejection elements) 153 are (two-dimensionally) arranged in a staggered matrix. The ink chamber units 153 are formed with the nozzles 151, which are ink ejection apertures, pressure chambers 152 corresponding with the nozzles 151, and suchlike. Accordingly, an increase in density of an actual spacing of nozzles, when projected into a line along the head length direction (a direction orthogonal to the paper feeding direction), (i.e., of a projected nozzle pitch) is achieved.

Modes configured with one or more nozzle rows extending over a length corresponding to the whole width of the recording paper 116 in the direction substantially orthogonal to the feeding direction of the recording paper 116 are not to be limited by the present example.

A plan view shape of the pressure chamber 152 that is provided in correspondence with each nozzle 151 is a substantially square shape (see FIG. 3 and FIG. 4). An outflow aperture to the nozzle 151 is provided at one of two corner portions on a diagonal of the pressure chamber 152, and an inflow aperture (supply aperture) 154 for supplied ink is provided at the other corner portion. The shape of the pressure chamber 152 is not to be limited by the present example; the plan view shape may be various shapes, such as quadrilateral shapes (rhomboids, rectangles and the like), pentagons, hexagons, other polygons, circles, ellipses, and so forth.

As illustrated in FIG. 5, the pressure chambers 152 are in fluid communication with a common channel 155 via the supply apertures 154. The common channel 155 is in fluid communication with an ink tank (not illustrated) which is an ink supply source. Ink supplied from the ink tank is distributed and supplied to the pressure chambers 152 via the common channel 155.

A pressure plate 156 (a diaphragm which is employed in combination with a common electrode) structures a portion of a face of the pressure chamber 152 (the top face in FIG. 5). An actuator 158 equipped with an individual electrode 157 is joined to the pressure plate 156. When a driving voltage is applied between the individual electrode 157 and the common electrode, the actuator 158 deforms and alters the volume of the pressure chamber 152. Accordingly, ink is ejected from the nozzle 151 by a change in pressure. Here, a piezoelectric element that employs a piezoelectric body of lead titanate silicate, barium titanate or the like may be employed. When the displacement of the actuator 158 returns to the original position after the ink ejection, new ink is recharged from the common channel 155 into the pressure chamber 152, through the supply aperture 154.

When driving of the actuators 158 corresponding to the nozzles 151 is controlled in accordance with dot distribution data generated from image information, ink droplets may be ejected from the nozzles 151. As described for FIG. 1, while the recording paper 116 that is the recording medium is being conveyed in the sub scanning direction at a constant speed, ejection timings of the nozzles 151 are controlled to match this conveyance speed. Thus, a desired image may be recorded on the recording paper 116.

Repeatedly performing printing of single lines formed by the above-described main scanning (lines of dots of a single row or lines formed of dots of plural rows), by relatively moving the above-described full line head and the paper, is defined as sub scanning.

The direction of drawing of the individual lines recorded by the above-described main scanning (or a strip region length direction) is referred to as the main scanning direction, and the direction in which the above-described sub scanning is performed is referred to as the sub scanning direction. That is, in the present exemplary embodiment, the direction of conveyance of the recording paper 116 is the sub scanning direction and a direction orthogonal thereto is referred to as the main scanning direction.

Structural arrangements of nozzles relating to embodiments of the present invention are not to be limited to the illustrated example. Moreover, although a system is employed in the present exemplary embodiment in which ink droplets are caused to shoot out by deformation of the actuator 158, which is represented as a piezo element (a piezoelectric element), systems for ejecting ink relating to embodiments of the present invention are not to be particularly limited. Various systems may be employed instead of the piezo jet system, such as a thermal jet system in which ink is heated by a heating body such as a heater or the like, air bubbles are formed and ink droplets are caused to shoot out by pressure therefrom, or the like.

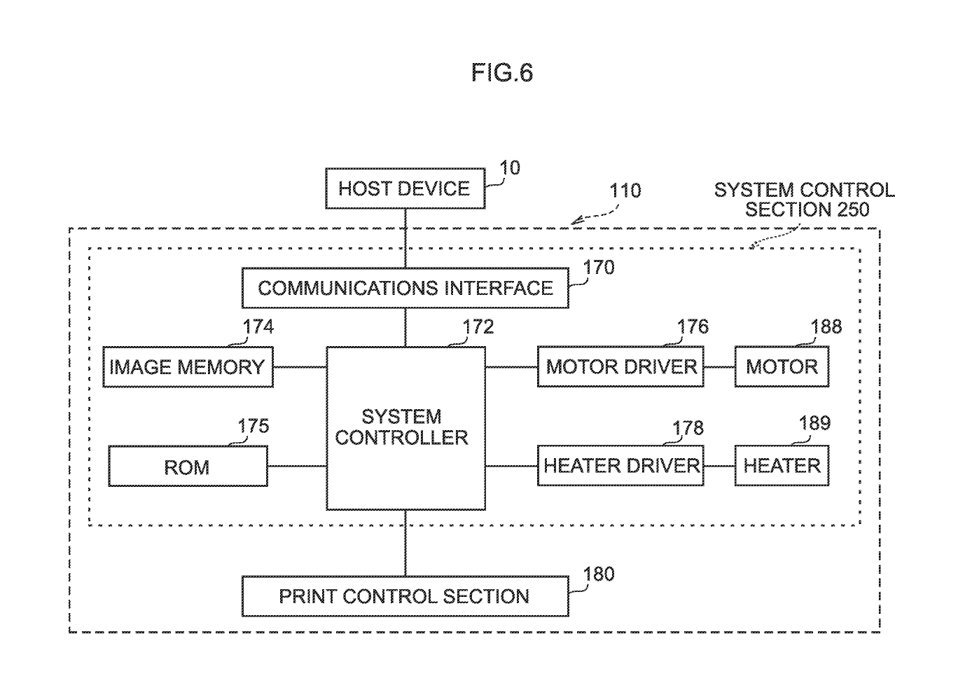

FIG. 6 is a block diagram illustrating system structure of the inkjet recording device 110. As illustrated in FIG. 6, the inkjet recording device 110 has a structure that includes and is principally divided into a system control section 250 and a print control section 180.

The system control section 250 is equipped with a communications interface 170, a system controller 172, an image memory 174, a ROM 175, a motor driver 176, a heater driver 178, a heater 189 and the like. This heater 189 collectively represents the aforementioned pre-heater 140, impact region heater 134 and drying heater 142.

The communications interface 170 is an interface with a host device 10, which is used by a user for giving printing instructions to the inkjet recording device 110 and the like. The communications interface 170 may employ a serial interface, such as USB (Universal Serial Bus), IEEE1394, ETHERNET (registered trademark), a wireless network or the like, or a parallel interface such as CENTRONICS or the like. Because the communications are at high speeds, a buffer memory (not illustrated) may be incorporated at this section.

Image data transmitted from the host device 10 is read into the inkjet recording device 110 via the communications interface 170, and is temporarily stored in the image memory 174. The image memory 174 is a storage unit that stores images inputted via the communications interface 170. Writing of data to the image memory 174 is implemented through the system controller 172. The image memory 174 is not limited to memories formed of semiconductor devices; magnetic media such as hard discs and the like may be used.

The system controller 172 is constituted with a central processing unit (CPU) and peripheral circuits thereof and the like, functions as a control device that performs overall control of the inkjet recording device 110 in accordance with a predetermined program, and functions as a computation device that carries out various computations. That is, the system controller 172 controls the communications interface 170, the image memory 174, the motor driver 176, the heater driver 178, the print control section 180 and other sections, controls communications with the host device 10, controls writing to the image memory 174 and the ROM 175, and so forth, and generates control signals that control a motor 188 of a conveyance system, the heater 189 and the like. In addition to control signals, image data stored in the image memory 174 is transmitted to the print control section 180.

Programs that are executed by the CPU of the system controller 172, various kinds of data required for control, and the like are stored in the ROM 175. The ROM 175 may be a non-writable memory. Alternatively, if updates of the various kinds of data are to be performed when necessary, using a rewritable storage unit such as an EEPROM is preferable.

The image memory 174 is employed as a temporary storage region for image data, and is also employed as a program development region and a calculation work region for the CPU.

The motor driver 176 is a driver (a driving circuit) that drives the motor 188 of the conveyance system in accordance with instructions from the system controller 172. The heater driver 178 is a driver that drives the heater 189 in accordance with instructions from the system controller 172. When the heater 189 is driving, temperatures of the impact region 210 and/or the recording paper 116 rise, and when the heater 189 is not driving, the temperatures of the impact region 210 and/or the recording paper 116 fall. Accordingly, temperatures of the impact region 210 and the recording paper 116 or the like may be regulated.

The print control section 180 functions as a signal processing section that carries out processing, such as various processes for generating signals for ejection droplet control from image data from the system control section 250, correction and the like, in accordance with control by the system controller 172. The print control section 180 also controls ejection driving of the head 150 on the basis of the generated ink ejection data.

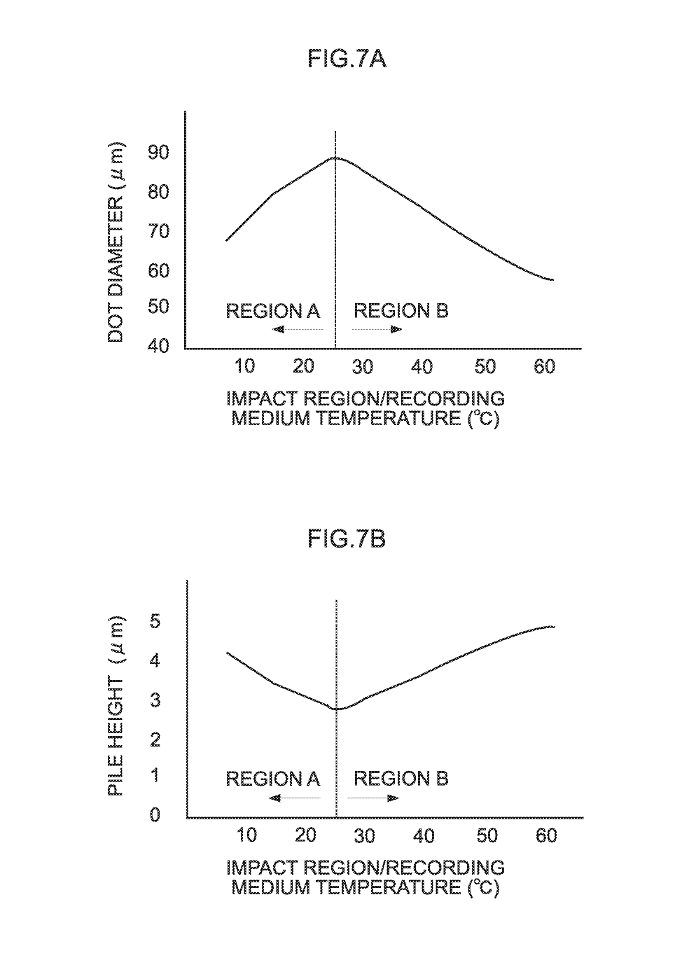

Next, impact area information, which represents a relationship between a temperature of the impact region 210, the recording paper 116 or the like and surface areas of ink that has impacted on the recording paper 116, and pile height information, which represents a relationship between a temperature of the impact region 210, the recording paper 116 or the like and pile heights of ink that has impacted on the recording paper 116, are described using FIG. 7A and FIG. 7B. In the present exemplary embodiment, the dots that are the impacted ink are represented as being substantially circular, with dot diameters being considered to be uniform.

FIG. 7A illustrates a relationship between temperatures of the impact region 210 or the recording paper 116 (the horizontal axis) and diameters of dots impacted on the recording paper 116 (the vertical axis). FIG. 7B illustrates a relationship between temperatures of the impact region 210 or the recording paper 116 (the horizontal axis) and pile heights of dots impacted on the recording paper 116 (the vertical axis).

Herein, for both of the graphs, a polyvinyl chloride sheet is used for the recording paper 116 and, as mentioned above, viscosity of the ink at room temperature is 11 cp and components thereof are 6% colorant, 7% resin and 80% organic solvent.

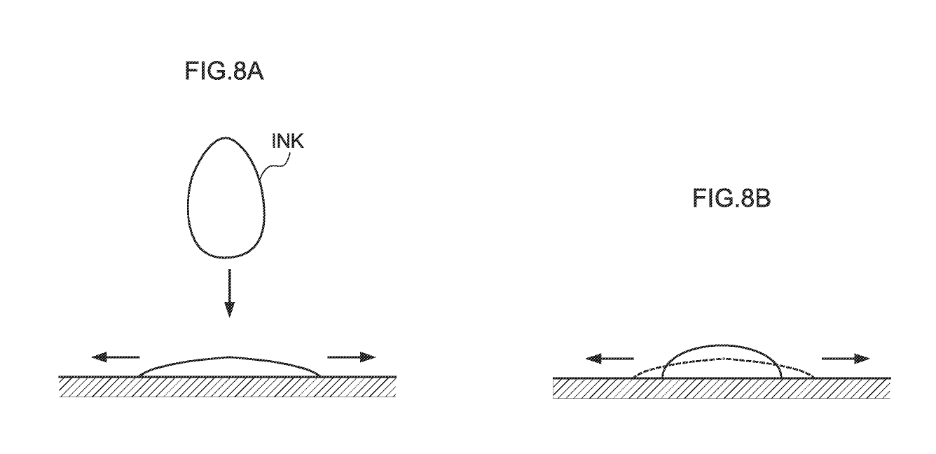

Dot diameters are determined by a balance between surface energy and viscosity. If the surface energy of the recording paper 116 is low, the dot diameter is large because of wetting spreading, as illustrated in FIG. 8A. On the other hand, if the ink viscosity is high, as illustrated in FIG. 8B, spreading force of the surface energy is suppressed by a thickening effect and the dot diameter is smaller.

In both FIG. 7A and FIG. 7B, a tendency is illustrated, bounded at 25° C., in which the dot diameter is fixed by the thickening effect due to evaporation of volatile components at above 25° C. (region B).

On the other hand, below 25° C. (region A), the thickening effect due to evaporation is smaller, and the influence of an ink viscosity—temperature characteristic is larger. Therefore, if the temperature is controlled to be 25° C. or less, stable control of dot diameters is difficult because of disturbances in the environment and suchlike. Therefore, in the present exemplary embodiment, dot diameters are controlled in the range of region B, which is a range of temperature in which the ink volatilizes.

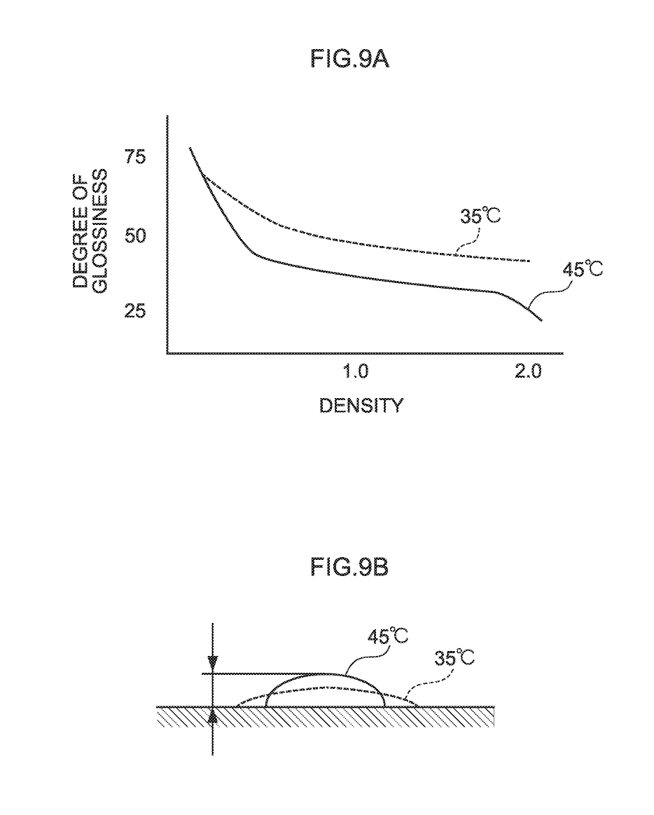

Concerning the pile height, pile height is inversely proportional to dot diameter, so produces the graph illustrated in FIG. 7B. The pile height has an effect on glossiness. The pile height is specifically described using FIG. 9A and FIG. 9B. In the graph illustrated in FIG. 9A, the horizontal axis represents density and the vertical axis represents the degree of glossiness. FIG. 9B is a view in which a dot is seen from sideways, which illustrates pile height. In both drawings, the broken lines represent a case in which the temperature of the impact region 210 or recording paper 116 is 35° C., and the solid lines represent a case in which the temperature of the impact region 210 or recording paper 116 is 45° C.

As illustrated in FIG. 9A, at 35° C., as the density increases the glossiness decreases gently, and at 45° C., when the density is larger than a certain density (around 1.8), the glossiness decreases rapidly.

As illustrated in FIG. 9B, because the dots are less inclined to spread at 45° C. because of greater evaporation, the pile height is larger than the pile height at 35° C. The greater this pile height, the lower the glossiness. Therefore, when glossiness is required, it is sufficient that the temperature be lower in the range of region B shown in FIG. 7B.

The above-described impact area information and pile height information illustrated in FIG. 7A and FIG. 7B, respectively, are obtained beforehand by experiment, and are stored in the ROM 175 as tables or as information represented by mathematical expressions. The impact area information and pile height information vary depending on types of the recording paper 116. Therefore, the impact area information and pile height information may be provided and stored for each of types of the recording paper 116.

Next, flows of impact area control processing and pile height processing are described using flowcharts. The impact area control processing and the pile height control processing are executed by the CPU of the system controller 172.

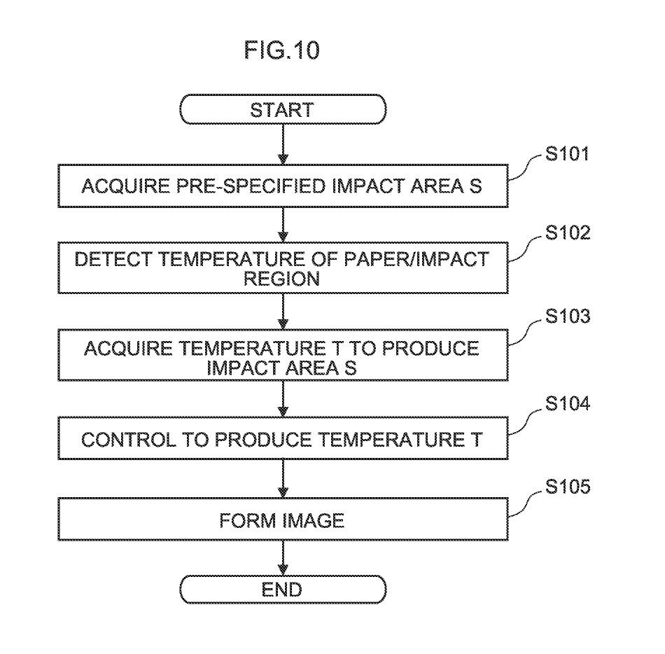

First, the flow of the impact area control processing is described using FIG. 10. In step 101, an impact area S specified beforehand is acquired. This pre-specified impact area S is, for example, an area designated by an operator or the like. At this time, the type of the recording paper 116 may also be acquired. The type of the recording paper 116 may be inputted by the operator, automatically detected from glossiness, or detected using a leading edge of the recording paper 116 or dedicated markings that have been applied to the recording paper 116 beforehand.

Then, in step 102, the temperature of the impact region 210 is detected by the impact region temperature detection section 202 or the temperature of the recording paper 116 is detected by the medium temperature detection section 200. Then, in step 103, a temperature T to produce the impact area S is acquired from the impact area information illustrated in FIG. 7A.

In step 104, the heater 189 is controlled to produce the temperature T and then, in step 105, an image is formed and the processing ends.

Thus, in step 102 to step 104, the heater 189 is controlled on the basis of the temperature of the impact region 210 or of the recording paper 116 and the impact area information illustrated in FIG. 7A such that impact areas of ink impacting on the recording paper 116 are the pre-specified impact area S.

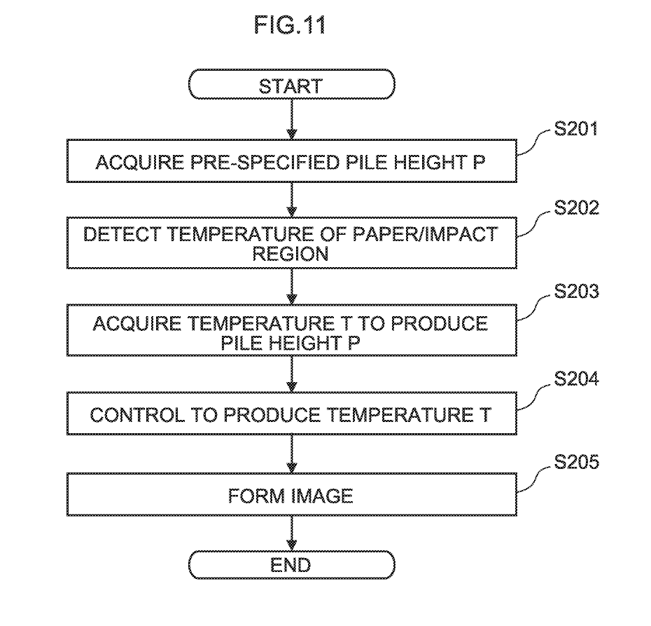

Next, the flow of the pile height control processing is described using FIG. 11. In step 201, a pile height P specified beforehand is acquired. This pre-specified pile height is, for example, a pile height designated by an operator or the like. At this time, the type of the recording paper 116 may also be acquired, in the same manner as in FIG. 10.

Then, in step 202, the temperature of the impact region 210 is detected by the impact region temperature detection section 202 or the temperature of the recording paper 116 is detected by the medium temperature detection section 200. Then, in step 203, a temperature T to produce the pile height P is acquired from the pile height information illustrated in FIG. 7B.

In step 204, the heater 189 is controlled to produce the temperature T and then, in step 205, an image is formed and the processing ends.

Thus, in step 202 to step 204, the heater 189 is controlled on the basis of the temperature of the impact region impact region 210 or of the recording paper 116 and the pile height information illustrated in FIG. 7B such that pile heights of ink impacting on the recording paper 116 are the pre-specified pile height P.

Herein, the flows of processing of the flowcharts described above are examples. Obviously, the sequences of processing may be rearranged, new steps may be added and unnecessary steps may be omitted, within a scope not departing from the spirit of the present invention.

Furthermore, the system controller 172 may also control a temperature of ink in the ink storage/charging section 114. In such a case, a heater that heats the ink storage/charging section 114 is provided and the system controller 172 may control the temperature of the ink such that the temperature of the ink becomes substantially the same as the temperature of the recording paper 116 or the impact region 210. Herein, the meaning of the term “substantially the same” includes being equal or approximately equal to accommodate device variations, errors caused by detectors and suchlike, and the like. In regard to the temperature of the impact region, the temperature of the impact region 210 according to the impact region temperature detection section 202 may be detected and the temperature of the ink made substantially equal to this temperature, or a temperature of the impact region 210 may be detected beforehand by testing and the temperature of the ink made substantially equal to this temperature.

In the exemplary embodiment described above, the inkjet recording device 110 that uses a single pass system is given as an example. However, a “shuttle” system that forms images by a head reciprocatingly scanning may be used.

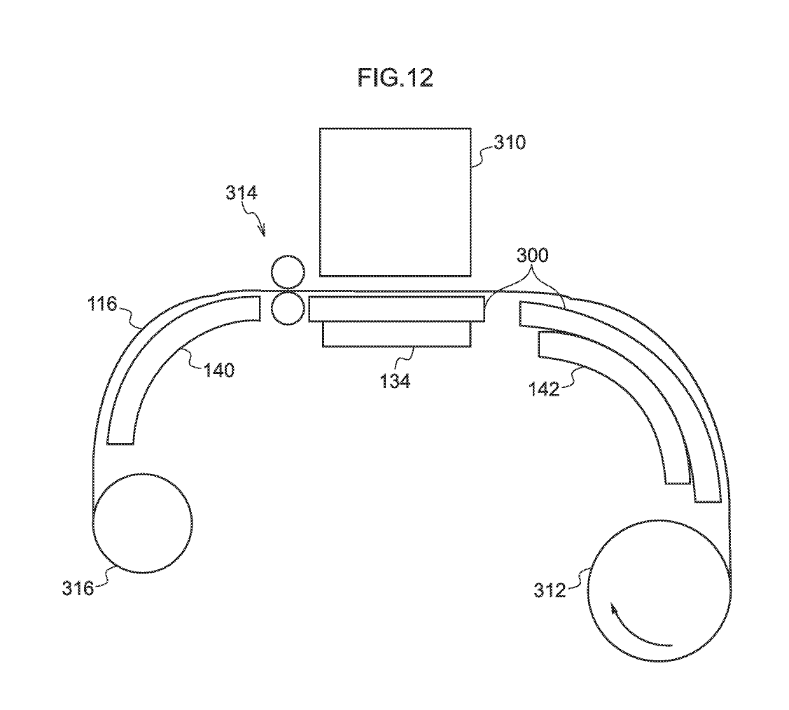

This is concretely described using FIG. 12. FIG. 12 is a diagram illustrating an example of a configuration of heaters in a shuttle system. As illustrated in FIG. 12, the configuration of the shuttle system has a structure that includes a head 310, a platen 300, sub scanning rollers 314, a paper roll supply section 316, a recording paper winding section 312, the pre-heater 140, the impact region heater 134 and the drying heater 142.

In the shuttle system, the recording paper 116 is fed from the paper roll supply section 316 by the sub scanning rollers 314, is intermittently fed, and is wound up on the recording paper winding section 312. The head 310 is moved in a main scanning direction (a direction orthogonal to the direction of movement of the recording paper 116), while ink is applied as drops to the recording paper 116 so as to form an image.

The impact region heater 134 raises the temperature of the impact region, via the platen 300. The drying heater 142 volatilizes volatile components included in the ink impacted on the recording paper 116 after the recording. The pre-heater 140 regulates the temperature of the recording paper 116. The pre-heater 140 regulates a prior rise in temperature of the recording paper 116 to the temperature of the impact region heater 134.

Thus, the recording medium heating device (the pre-heater 140) is disposed at the upstream side of the impact area (the impact region 210), and raises the temperature of the recording paper 116 to substantially equal the regulation temperature of the impact region (the temperature of the impact region heater 134).

Thus, the present exemplary embodiment may be applied to this kind of shuttle system inkjet recording device too.

Now, in the aspect of the invention recited above, the droplets including the volatile component are ejected at the recording medium by the droplet ejection head, and the temperature of the recording medium is detected by the medium temperature detection unit. The impact area information representing the relationship between temperatures of the recording medium and impact areas of droplets impacting on the recording medium is stored at the storage unit. On the basis of the temperature of the recording medium detected by the medium temperature detection unit and the impact area information stored by the storage unit, the temperature of the recording medium is controlled by the medium temperature control unit such that impact areas of the droplets impacting on the recording medium will be the pre-specified impact area. Thus, an image forming device capable of controlling the impact areas when droplets including the volatile component are impacting may be provided.

In the above aspect, the impact area information may be provided for each of types of the recording medium.

According to the above aspect, because impact areas differ with types of recording medium even at the same temperature, the impact area information is provided for each type of recording medium, and the impact areas may be controlled more accurately.

In the above aspects, the medium temperature control unit may control the temperature of the recording medium within a range of temperatures in which the droplets volatilize.

According to the above aspect, the temperature is controlled within a range of temperatures that cause volatilization. Thus, because the volatile component may be volatilized, the impact areas may be controlled more accurately.

The above aspects may further include a droplet temperature control unit that controls a temperature of the droplets, wherein the droplet temperature control unit performs control such that the temperature of the droplets is substantially the same as the temperature of the recording medium.

According to the above aspect, because the temperatures of the recording medium and the droplets are made substantially the same, rises and falls in temperature may be avoided. Therefore, the impact areas may be controlled more accurately.

An image forming device relating to an aspect of the present invention includes: a droplet ejection head that ejects droplets including a volatile component at a recording medium; an impact region temperature detection unit that detects a temperature of an impact region in which the droplets ejected by the droplet ejection head impact on the recording medium; a storage unit that stores impact area information representing a relationship between temperatures of the impact region and impact areas of droplets impacting on the recording medium; and an impact region temperature control unit that, on the basis of the temperature of the impact region detected by the impact region temperature detection unit and the impact area information stored by the storage unit, controls the temperature of the impact region such that impact areas of the droplets impacting on the recording medium are substantially equal to a pre-specified impact area.

According to the aspect of the invention recited above, the droplets including the volatile component are ejected at the recording medium by the droplet ejection head, the temperature of the impact region on which the droplets ejected by the droplet ejection head impact is detected by the impact region temperature detection unit, and the temperature of the impact region is regulated by the impact region temperature control unit. The impact area information representing the relationship between temperatures of the impact region and impact areas of droplets impacting on the recording medium is stored at the storage unit. On the basis of the temperature of the impact region detected by the impact region temperature detection unit and the impact area information stored by the storage unit, the temperature of the impact region is controlled by the impact region temperature control unit such that impact areas of the droplets impacting on the recording medium will be the pre-specified impact area. Thus, an image forming device capable of controlling the impact areas when droplets including the volatile component are impacting may be provided.

In the above aspect, the impact area information may be provided for each of types of the recording medium.

According to the above aspect, because impact areas differ with types of recording medium even at the same temperature, the impact area information is provided for each type of recording medium, and the impact areas may be controlled more accurately.

In the above aspects, the impact region temperature control unit may control the temperature of the impact region within a range of temperatures in which the droplets volatilize.

According to the above aspect, the temperature is controlled within a range of temperatures that cause volatilization. Thus, because the volatile component may be the volatilized, the impact areas may be controlled more accurately.

The above aspects may further include a droplet temperature control unit that controls a temperature of the droplets, wherein the droplet temperature control unit performs control such that the temperature of the droplets is substantially the same as the temperature of the recording medium.

According to the above aspect, because the temperatures of the impact region and the droplets are made substantially the same, rises and falls in temperature may be avoided. Therefore, the impact areas may be controlled more accurately.

The above aspects may further include a volatilization unit that volatilizes the volatile component included in the droplets impacting on the recording medium with a temperature of at least a temperature of an impact region in which the droplets ejected by the droplet ejection head impact on the recording medium.

According to the above aspect, faster volatilization is possible. Therefore, the quality of images that are formed may be improved.

In the above aspects, the droplets may include a colorant, a dye and a polymer.

According to the above aspect, droplets that include colorants, dyes and polymers may be used.

In the above aspects, a recording medium heating device may be disposed at an upstream side of an impact area, and raise a temperature of the recording medium to substantially the same as an impact region regulation temperature.

According to the above aspect, the temperature of the recording medium and the temperature of the impact region are made substantially the same. Thus, because the temperature of the recording medium reaches the temperature of the impact region faster, the impact areas may be controlled more accurately.

According to the present invention, an effect is provided in that an image forming device capable of controlling impact areas when droplets including a volatile component are impacting may be provided.

What is claimed is:

1. An image forming device comprising:
a droplet ejection head that ejects droplets, which includes a volatile component, onto a recording medium;
a medium temperature detection unit that detects a temperature of the recording medium;
a storage unit that stores impact area information representing a relationship between temperatures of the recording medium and impact areas of droplets impacting on the recording medium; and
a medium temperature control unit that, on the basis of the temperature of the recording medium detected by the medium temperature detection unit and the impact area information stored by the storage unit, controls the temperature of the recording medium such that impact areas of the droplets impacting on the recording medium are each substantially equal to a pre-specified impact area.

2. The image forming device according to claim 1, wherein the impact area information is provided for each of a plurality of types of the recording medium.

3. The image forming device according to claim 1, wherein the medium temperature control unit controls the temperature of the recording medium within a range of temperatures in which the droplets volatilize.

4. The image forming device according to claim 2, wherein the medium temperature control unit controls the temperature of the recording medium within a range of temperatures in which the droplets volatilize.

5. The image forming device according to claim 1, further comprising a droplet temperature control unit that controls a temperature of the droplets,
wherein the droplet temperature control unit performs control such that the temperature of the droplets is substantially the same as the temperature of the recording medium.

6. The image forming device according to claim 2, further comprising a droplet temperature control unit that controls a temperature of the droplets,
wherein the droplet temperature control unit performs control such that the temperature of the droplets is substantially the same as the temperature of the recording medium.

7. The image forming device according to claim 3, further comprising a droplet temperature control unit that controls a temperature of the droplets,
wherein the droplet temperature control unit performs control such that the temperature of the droplets is substantially the same as the temperature of the recording medium.

8. An image forming device comprising:
a droplet ejection head that ejects droplets, which includes a volatile component, onto a recording medium;
an impact region temperature detection unit that detects a temperature of an impact region in which the droplets ejected by the droplet ejection head impact on the recording medium;
a storage unit that stores impact area information representing a relationship between temperatures of the impact region and impact areas of droplets impacting on the recording medium; and
an impact region temperature control unit that, on the basis of the temperature of the impact region detected by the impact region temperature detection unit and the impact area information stored by the storage unit, controls the temperature of the impact region such that impact areas of the droplets impacting on the recording medium are each substantially equal to a pre-specified impact area.

9. The image forming device according to claim 8, wherein the impact area information is provided for each of plurality of types of the recording medium.

10. The image forming device according to claim 8, wherein the impact region temperature control unit controls the temperature of the impact region within a range of temperatures in which the droplets volatilize.

11. The image forming device according to claim 9, wherein the impact region temperature control unit controls the temperature of the impact region within a range of temperatures in which the droplets volatilize.

12. The image forming device according to claim 8, further comprising a droplet temperature control unit that controls a temperature of the droplets,
wherein the droplet temperature control unit performs control such that the temperature of the droplets is substantially the same as the temperature of the recording medium.

13. The image forming device according to claim 9, further comprising a droplet temperature control unit that controls a temperature of the droplets,
wherein the droplet temperature control unit performs control such that the temperature of the droplets is substantially the same as the temperature of the recording medium.

14. The image forming device according to claim 10, further comprising a droplet temperature control unit that controls a temperature of the droplets,
wherein the droplet temperature control unit performs control such that the temperature of the droplets is substantially the same as the temperature of the recording medium.

15. The image forming device according to claim 1, further comprising a volatilization unit that volatilizes the volatile component included in the droplets impacting on the recording medium with a temperature of at least a temperature of an impact region in which the droplets ejected by the droplet ejection head impact on the recording medium.

16. The image forming device according to claim 8, further comprising a volatilization unit that volatilizes the volatile component included in the droplets impacting on the recording medium with a temperature of at least the temperature of the impact region in which the droplets ejected by the droplet ejection head impact on the recording medium.

17. The image forming device according to claim 1, wherein the droplets include a colorant, a dye and a polymer.

18. The image forming device according to claim 8, wherein the droplets include a colorant, a dye and a polymer.

19. The image forming device according to claim 1, wherein a recording medium heating device is disposed at an upstream side of an impact area, and raises a temperature of the recording medium to substantially the same as a predetermined impact region regulation temperature.

20. The image forming device according to claim 8, wherein a recording medium heating device is disposed at an upstream side of an impact area, and raises a temperature of the recording medium to substantially the same as a predetermined impact region regulation temperature.
